(19) United States
(12) Patent Application Publication
(10) Pub. No.: US 2024/0376617 A1
(43) Pub. Date: Nov. 14, 2024

(54) A CATALYST, ITS APPLICATION IN PRODUCTION OF HYDROGEN

(71) Applicant: JAWAHARLAL NEHRU CENTRE FOR ADVANCED SCIENTIFIC RESEARCH, Jakkur, Bangalore (IN)

(72) Inventors: Sebastian Chirambatte PETER, Jakkur, Bangalore (IN); Soumi MONDAL, Jakkur, Bangalore (IN)

(21) Appl. No.: 18/684,615

(22) PCT Filed: Aug. 17, 2022
(86) PCT No.: PCT/IN2022/050741

§ 371 Date: Feb. 16, 2024

(30) Foreign Application Priority Data
Aug. 17, 2021 (IN) 202141037359

(51) Int. Cl. C25B 11/089; C25B 1/04

(52) U.S. Cl. CPC C25B 11/089; C25B 1/04

(57) ABSTRACT

The present disclosure provides a catalyst comprising a compound comprising an ordered intermetallic of platinum and germanium having formula Pt₃Ge, wherein Pt₃Ge has a single crystallographic facet oriented in 202 plane. The present disclosure provides a catalyst for catalyzing hydrogen evolution reaction. The present disclosure also provides a catalyst ink, an electrode, an electrochemical cell, and methods thereof.

### TECHNICAL FIELD

The present disclosure relates to a catalyst and its application for the production of hydrogen. In particular, the present disclosure relates to an ordered intermetallic compound of platinum and germanium. The present disclosure further relates to an electrode and an electrochemical cell for the production of hydrogen.

### BACKGROUND OF THE INVENTION

Hydrogen is a carbon-free alternative energy source for use in future energy frameworks with the advantages of environment-friendliness and high energy density. Electrocatalytic hydrogen evolution reaction (HER) is recognized as a promising way for the production of sustainable hydrogen with water electrolyzers and to generate clean hydrogen energy. The hydrogen energy system is a potential pathway for providing energy, and can gradually replace the traditional fossil-based energy. However, its large-scale application requires the development of efficient catalysts.

Highly effective, durable, and cost-effective electrocatalysts for the hydrogen evolution reaction (HER) is a prerequisite. HER is exhibited best by noble metals like Pt, Pd, and Ru, mostly, Pt. Platinum is scarce in the earth's crust and bears an exorbitant price when considered to be implemented on large scale. Platinum has been considered the best catalyst with respect to onset potential and current density. Platinum still has drawbacks of poor stability and catalyst degradation, specifically, poor stability in alkaline medium HER. Further, it is very difficult to substitute Pt with respect to the activity. Efforts are being carried out to enhance the activity of materials by synthesizing either non-Pt catalysts or less-Pt containing compounds. But it is difficult to decrease Pt loading and achieve Pt-like activity.

Therefore, developing electrocatalysts for water electrolysis is an emerging field with great importance to the scientific community. Pt-based intermetallic compounds with non-precious elements are expected to shrink the cost if they can surpass the performance towards electrocatalytic hydrogen evolution (HER) compared to the existing platinum catalyst.

Extensive research is going on to maximize the catalytic activity of Pt accompanied by its decreased mass loading. Tuning the electronic property of Pt can give better activity and structural stability. Platinum can be tuned by alloying with other transition elements, a heterostructures formation like core-shell, Pt modified metal carbides and nitrides, single-atom catalysts, or developing intermetallic with non-precious elements but Pt-like activity and durability towards HER have never been achieved.

Hence, it is extremely necessary to develop an earth-abundant material low Pt-containing HER catalyst which is cost effective and can trigger hydrogen evolution with Pt-like fast kinetics with minimum overpotential, high current density, stability, durability, and wide range of applicability.

### SUMMARY OF THE INVENTION

In an aspect of the present disclosure, there is provided a catalyst comprising: a compound comprising an ordered intermetallic of platinum and germanium having formula Pt₃Ge, wherein Pt₃Ge has a single crystallographic facet oriented in 202 plane.

In another aspect of the present disclosure, there is provided a process for preparing the catalyst comprising: a compound comprising an ordered intermetallic of platinum and germanium having formula Pt₃Ge, wherein Pt₃Ge has a single crystallographic facet oriented in 202 plane, the process comprising: a) mixing a platinum precursor, a germanium precursor and a reducing agent in a first solvent to obtain a first mixture; b) heating the first mixture at a temperature in a range of 200 to 250°° C. for a time period in a range of 24 to 48 hours to obtain the compound, wherein the platinum precursor and the germanium precursor is taken in a molar ratio range of 0.9:0.8 to 1.5:1.2.

In yet another aspect of the present disclosure, there is provided a catalyst ink comprising: a) the catalyst comprising: a compound comprising: an ordered intermetallic of platinum and germanium having formula Pt₃Ge, wherein Pt₃Ge has a single crystallographic facet oriented in 202 plane; b) an activated carbon; and c) a binder, wherein the catalyst and the activated carbon is in a weight ratio range of 1:1 to 5:1.

In one another aspect of the present disclosure, there is provided an electrode comprising: a) a substrate; and b) the catalyst ink comprising: i) the catalyst comprising: a compound comprising an ordered intermetallic of platinum and germanium having formula Pt₃Ge, wherein Pt₃Ge has a single crystallographic facet oriented in 202 plane; ii) an activated carbon; and iii) a binder, wherein the catalyst and the activated carbon is in a weight ratio range of 1:1 to 5:1.

In further aspect of the present disclosure, there is provided an electrochemical cell comprising: i) a working electrode comprising: a) a substrate; and b) the catalyst ink as disclosed herein; ii) a counter electrode; and iii) a reference electrode, wherein the electrochemical cell exhibits current density in a range of 1800 to 2200 mA/cm^{2.}

In more aspect of the present disclosure, there is provided a process for production of hydrogen, the process comprising: a) contacting the electrochemical cell as disclosed herein with an electrolyte; and b) generating hydrogen by electrolyzing the electrolyte at an onset potential in the range of 0 to −0.6V. In another aspect of the present disclosure, there is provided a cell

comprising the electrode comprising: a) a substrate; and b) the catalyst ink as disclosed herein, or the electrochemical cell comprising: i) a working electrode comprising the electrode comprising: A) a substrate; and B) the catalyst ink; ii) a counter electrode; and iii) a reference electrode, wherein the electrochemical cell exhibits current density in a range of 1800 to 2200 mA/cm^{2.}

In furthermore aspect of the present disclosure, there is provided an apparatus for production of hydrogen comprising the electrochemical cell comprising: i) a working electrode comprising the electrode comprising: a) a substrate; and b) the catalyst ink as disclosed herein; ii) a counter electrode; and iii) a reference electrode, wherein the electrochemical cell exhibits current density in a range of 1800 to 2200 mA/cm^{2.}

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE ACCOMPANYING FIGURES

In order that the disclosure may be readily understood and put into practical effect, reference will now be made to exemplary embodiments as illustrated with reference to the accompanying figures. The figures together with a detailed description below, are incorporated in and form part of the specification, and serve to further illustrate the embodiments and explain various principles and advantages, in accordance with the present disclosure wherein:

FIG. 1 depicts a) the powder x-ray diffraction patterns of the catalyst and b) the rietvield analysis of Pt₃Ge, in accordance with an implementation of the present disclosure.

FIG. 2 (a, b, f, g) depict the high-resolution transmission electron microscopic (HR-TEM) images of the Pt-Ge compounds, FIG. 2 (c, h) depict the scanning electron microscopic images and FIG. 2 (d, e, i, j) depict the colour mapping from energy dispersive X-ray spectrum of the Pt-Ge compounds, in accordance with an implementation of the present disclosure.

FIG. 3 depicts the particle size distribution of (a) Pt₃Ge (110) and (b) Pt₃Ge (202), in accordance with an implementation of the present disclosure.

FIG. 4 depicts (a) spatial arrangement of Pt and Ge in Pt₃Ge; (b) crystallographic planes of Pt₃Ge (110) and Pt₃Ge (202); (c) tetragonal phase of Pt₃Ge and orthorhombic phase of Pt₃Ge₂; and (d) the schematic representation of formation of Pt₃Ge (202), in accordance with an implementation of the present disclosure.

FIG. 5 depicts the (a) the linear sweep voltammograms (LSVs) of Pt₃Ge (110), Pt₃Ge (202), and 20% Pt/C in acidic condition; (b) the LSV data taken using rotating disk electrode; (c) the tafel slope for Pt₃Ge (110) and Pt₃Ge (202); (d) current density measurements before and after 15000 ADT cycles; and (e) chronoamperometry data of Pt₃Ge (202), in accordance with an implementation of the present disclosure.

FIG. 6 (a, b) depict the comparative example of current density measurement from Pt₃Ge (110), in accordance with an implementation of the present disclosure.

FIG. 7 depicts the electrochemically active surface area calculations from double-layer capacitance of Pt₃Ge (202), in accordance with an implementation of the present disclosure.

FIG. 8 depicts (a, b) cyclic voltammograms (CV) of Pt₃Ge (110) and Pt₃Ge (202); (c) the CV activation cycles vs the current density of Pt₃Ge (110) and Pt₃Ge (202); (d) the current density with respect to the number of ADT (accelerated durability test) cycles for Pt₃Ge (202); and (e) post-HER PXRD pattern of Pt₃Ge (202), in accordance with an implementation of the present disclosure.

FIG. 9 depicts (a) the linear sweep voltammograms (LSVs) of Pt₃Ge (110), Pt₃Ge (202), and 20% Pt/C in alkaline medium; (b) the tafel slope for Pt₃Ge (110) and Pt₃Ge (202); and (c) current density measurements before and after 5000ADT cycles of Pt₃Ge (202), in accordance with an implementation of the present disclosure.

FIG. 10 depicts (a, b) Pt L3-edge spectra X-ray absorption Near Edge spectra (XANES) and the X-ray absorption fine structure (XAFS) R-space data, respectively, in accordance with an implementation of the present disclosure.

FIG. 11 (a-d) depicts the fitted R-space and k-space data of Pt₃Ge (110) and Pt₃Ge (202), in accordance with an implementation of the present disclosure.

FIG. 12 (a, b) depicts the in-situ IR (infra-red) spectroscopy during 30 mins chronoamperometric study of Pt₃Ge (110) and Pt₃Ge (202) respectively; (c) the probable stretching vibrational frequencies; (d) the schematic of the HER mechanism as derived from the in-situ ATR FTIR (attenuated total reflectance-Fourier transform infrared spectroscopy) studies; and (e) a combined plot of Pt-based catalysts for acidic HER, in accordance with an implementation of the present disclosure.

FIG. 13 depicts (a) SEM (scanning electron microscopic) image of a Pt₃Ge (110); (b) and (c) the color mapping of Pt and Ge in Pt₃Ge (110), respectively; (d) SEM image of Pt₃Ge (110) particles before and (e) after 15000 ADT cycles, in accordance with an implementation of the present disclosure.

FIG. 14 depicts (a) and (b) TEM (transmission electron microscopic) image of a Pt₃Ge (110); and (c) TEM image of a Pt₃Ge (202); (d) SEM image of Pt₃Ge (202) particles before and (e) after 15000 ADT cycles of Pt₃Ge (202), in accordance with an implementation of the present disclosure.

### DETAILED DESCRIPTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

In the structural formulae given herein and throughout the present disclosure, the following terms have been indicated meaning, unless specifically stated otherwise.

The term “at least one” is used to mean one or more and thus includes individual components as well as mixtures/combinations.

The term “intermetallic compound” refers to a compound comprising two or more metals. In the present disclosure, the intermetallic compound refers to a compound comprising Pt and Ge, particularly a structurally ordered intermetallic compound of formula Pt₃Ge with selective orientation of 202 plane and is represented as Pt₃Ge (202). Similarly, when Pt₃Ge crystallizes in 110 plane it is represented as Pt₃Ge (110) and is used for comparative purposes.

The term “crystallographic facet” refers to the plane of orientation of the atoms/molecules in a crystal structure. In the present disclosure, Pt₃Ge crystallizes in 202 plane and has a crystallographic facet with hkl (miller indices) values as 202.

The term “space group” refers to the symmetry group of a configuration of atoms/molecules in space, usually in three dimensions. The periodic arrangements of atoms in space is referred to as space group. In the present disclosure, Pt₃Ge has a tetragonal crystal structure with space group 14/mcm.

The term “over potential” refers to the potential difference (voltage) between a half-reaction's thermodynamically determined reduction potential and the potential at which the redox event is experimentally observed. The term is directly related to a cell's voltage efficiency. The lower the overpotential the higher is the efficiency of the cell. In the present disclosure, the electrode comprising the catalyst Pt₃Ge (202) possesses lower overpotential which is an advantageous feature in the process of production of hydrogen.

The term “onset potential” refers to the potential at a point where an electrochemical process starts. The lower the onset potential, the electrochemical reactions start at a lower potential region and favours faster kinetics of the reaction.

The term “electrochemically active surface area (ECSA)” refers to a number of active sites in the electrode for electron transfer and is measured in farad per unit area. In the present disclosure, ECSA of the electrode is in a range of 14 to 18mF/cm^{2.}

The term “ADT (accelerated durability test) cycles” refers to a testing method which imparts electrochemical stress to the catalyst surface by making the catalyst surface face reduction and oxidation potential sweeps in the potential window where the reaction takes place. The greater number of ADT cycles a catalyst bears without current degradation, the more is the stability of the catalyst.

The term “durable” or “durability” refers to the ability of the catalyst to produce a fixed current density under a particular potential for a longer duration. The longer a catalyst holds the constant current density, more durable is the catalyst.

A term once described, the same meaning applies to it, throughout the disclosure.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

As discussed in the background, there is a need in the state of art to develop Pt catalysts for HER reaction but with lesser Pt and higher of other abundantly available materials yet provide increased catalytic activity. One such model is to alloy 3d transition metals (TMs) or p block elements with Pt metal. Combining 3d metals (TMs) or p block elements changes the 5d electron occupancy of Pt, Pt-Pt interatomic distance, leading to downshift of d-band center modifying the electronic structure. The electronic structure modification improves the intermediate stability on the surface and lowers the activation barrier of the reaction. Germanium is reported for its tendency to form hydrides in an acidic medium and promote HER while incorporated with other active noble metals like ruthenium and palladium. Due to the stable formation of GeH and GeH₂, there is an expected enhancement of reaction kinetics of HER. Non-similar adjacent atoms lead to charge separation, which make H-H coupling even more feasible.

Accordingly, the present disclosure provides an intermetallic compound which comprises Pt₃Ge with a crystallographic facet oriented in 202 plane. The present disclosure provides a low-cost metal alloyed Pt compound with better activity than Pt metal. Partial replacement of Pt atoms by Ge is highly cost-effective since the price of Ge is 1/10^{th} of Pt which addresses the cost issues of the catalyst. The catalyst fulfilled all the required parameters such as low onset potential, high current density, high stability and active in a long-range pH (active both in acidic and alkaline media). The specific orientation of the catalyst provides an increased electrochemically active surface area which in turn results in enhanced stability and activity of the catalyst. The present disclosure also provides a solvothermal process for preparing the catalyst with a single crystallographic facet. The present disclosure further provides an electrode comprising the catalyst and an electrochemical cell for HER reaction. The electrochemical cell electrolyzes an electrolyte to obtain hydrogen in both acidic and alkaline medium with current density in a range of 1800 to 2200 mA/cm^{2.}

In an embodiment of the present disclosure, there is provided a catalyst comprising: a compound comprising an ordered intermetallic of platinum and germanium having formula Pt₃Ge, wherein Pt₃Ge has a single crystallographic facet oriented in 202 plane.

In an embodiment of the present disclosure, there is provided a catalyst as disclosed herein, wherein the compound crystallizes in tetragonal system having a space group 14/mcm.

In an embodiment of the present disclosure, there is provided a catalyst as disclosed herein, wherein the catalyst exhibits an overpotential in a range of 15 to 25 mV at 10 mA/cm² in acidic medium and 94 mV to 98 mV at 10 mA/cm² in alkaline medium. In another embodiment of the present disclosure, wherein the catalyst exhibits an overpotential in a range of 17 to 22 mV at 10 mA/cm² in acidic medium and 95 mV to 97 mV at 10 mA/cm² in alkaline medium. In yet another embodiment of the present disclosure, wherein the catalyst exhibits an overpotential of 21.7 mV at 10 mA/cm² in acidic medium and 96 mV at 10 mA/cm² in alkaline medium.

In an embodiment of the present disclosure, there is provided a catalyst as disclosed herein, wherein the catalyst exhibits an overpotential in a range of 15 to 25 mV at 10 mA/cm² in acidic medium, 94 mV to 98 mV at 10 mA/cm² in alkaline medium, and the entire potential in a range of 0 V to −0.6 V vs. RHE (reversible hydrogen electrode).

In an embodiment of the present disclosure, there is provided a catalyst comprising: a compound comprising an ordered intermetallic of platinum and germanium having formula Pt₃Ge, wherein Pt₃Ge has a single crystallographic facet oriented in 202 plane crystallized in tetragonal system having a space group 14/mcm; and exhibits an overpotential in a range of 15 to 25 mV at 10 mA/cm² in acidic medium and 94 mV to 98 mV for 10 mA/cm² in alkaline medium.

In an embodiment of the present disclosure, there is provided a process for preparing the catalyst comprising: a compound comprising an ordered intermetallic of platinum and germanium having formula Pt₃Ge, wherein Pt₃Ge has a single crystallographic facet oriented in 202 plane, the process comprising: a) mixing a platinum precursor, a germanium precursor and a reducing agent in a first solvent to obtain a first mixture; b) heating the first mixture at a temperature in a range of 200 to 250° C. for a time period in a range of 24 to 48 hours to obtain the catalyst, wherein the platinum precursor and the germanium precursor is taken in a molar ratio range of 0.9:0.8 to 1.5:1.2.

In an embodiment of the present disclosure, there is provided a process for preparing the catalyst as disclosed herein, wherein the platinum precursor and the germanium precursor is taken in a molar ratio range of 1:0.9 to 1.3:1.2. In another embodiment of the present disclosure, wherein the platinum precursor and the germanium precursor is taken in the molar ratio of 1:1.

In an embodiment of the present disclosure, there is provided a process for preparing the catalyst as disclosed herein, wherein heating the first mixture at a temperature in a range of 210 to 240° C. for a time period in a range of 30 to 45 hours to obtain the catalyst. In another embodiment of the present disclosure, the heating of the first mixture is carried out at a temperature in a range of 215 to 230° C. for a time period in a range of 35 to 40 hours to obtain the catalyst. In yet another embodiment of the present disclosure, the heating of the first mixture is carried out at a temperature of 220° C. for a time period of 36 hours to obtain the catalyst.

In an embodiment of the present disclosure, there is provided a process for preparing the catalyst as disclosed herein, wherein the platinum precursor is K₂PtCl₄; the germanium precursor is GeCl₄; the reducing agent is lithium triethyl borohydride; and the first solvent is triethylene glycol.

In an embodiment of the present disclosure, there is provided a process for preparing the catalyst as disclosed herein, wherein the catalyst is subjected to washing and drying.

In an embodiment of the present disclosure, there is provided a process for preparing the catalyst comprising: a compound comprising an ordered intermetallic of platinum and germanium having formula Pt₃Ge, wherein Pt₃Ge has a single crystallographic facet oriented in 202 plane, the process comprising: a) mixing K₂PtCl₄, GeCl₄ in the 1:1 molar ratio with lithium triethyl borohydride in triethylene glycol to obtain a first mixture; b) heating the first mixture at a temperature of 220° C. for a time period of 36 hours to obtain the catalyst, and the catalyst is subjected to washing with ethanol followed by drying.

In an embodiment of the present disclosure, there is provided a catalyst ink comprising: (i) the catalyst comprising: a compound comprising an ordered intermetallic of platinum and germanium having formula Pt₃Ge, wherein Pt₃Ge has a single crystallographic facet oriented in 202 plane; (ii) an activated carbon; and (iii) a binder, wherein the catalyst and the activated carbon is in a weight ratio range of 1:1 to 5:1.

In an embodiment of the present disclosure, there is provided a catalyst ink as disclosed herein, wherein the catalyst and the activated carbon is in a weight ratio range of 2:1 to 5:1. In another embodiment of the present disclosure, the catalyst and the activated carbon is in a weight ratio range of 3:1 to 5:1. In yet another embodiment of the present disclosure, the catalyst and the activated carbon is in a weight ratio of 4:1.

In an embodiment of the present disclosure, there is provided a catalyst ink as disclosed herein, wherein the catalyst ink further comprises a second solvent; and the second solvent is selected from water, isopropanol, or combinations thereof.

In an embodiment of the present disclosure, there is provided a catalyst ink as disclosed herein, wherein the activated carbon is vulcan; and the binder is nafion.

In an embodiment of the present disclosure, there is provided a catalyst ink comprising (i) the catalyst comprising: a compound comprising an ordered intermetallic of platinum and germanium having formula Pt₃Ge, wherein Pt₃Ge has a single crystallographic facet oriented in 202 plane; (ii) vulcan; (iii) nafion; (iv) isopropanol; and (v) water, wherein the catalyst and vulcan is in a weight ratio range of 1:1 to 5:1.

In an embodiment of the present disclosure, there is provided an electrode comprising: (a) a substrate; and (b) the catalyst ink comprising: (i) the catalyst comprising: a compound comprising an ordered intermetallic of platinum and germanium having formula Pt₃Ge, wherein Pt₃Ge has a single crystallographic facet oriented in 202 plane; (ii) an activated carbon; and (iii) a binder, wherein the catalyst and the activated carbon is in a weight ratio range of 1:1 to 5:1.

In an embodiment of the present disclosure, there is provided an electrode comprising: (a) a substrate; and (b) the catalyst ink comprising: (i) the catalyst comprising: a compound comprising an ordered intermetallic of platinum and germanium having formula Pt₃Ge, wherein Pt₃Ge has a single crystallographic facet oriented in 202 plane; (ii) an activated carbon; (iii) a binder; and (iv) a second solvent selected from water, isopropanol, or combinations thereof, wherein the catalyst and the activated carbon is in a weight ratio range of 1:1 to 5:1.

In an embodiment of the present disclosure, there is provided an electrode as disclosed herein, wherein the substrate is glassy carbon.

In an embodiment of the present disclosure, there is provided an electrode comprising: (a) glassy carbon; and (b) the catalyst ink comprising: (i) the catalyst comprising: a compound comprising an ordered intermetallic of platinum and germanium having formula Pt₃Ge, wherein Pt₃Ge has a single crystallographic facet oriented in 202 plane; (ii) an activated carbon; (iii) a binder; and (iv) a second solvent selected from water, isopropanol, or combinations thereof, wherein the catalyst and the activated carbon is in a weight ratio range of 1:1 to 5:1.

In an embodiment of the present disclosure, there is provided an electrode as disclosed herein, wherein the substrate is coated with the catalyst ink by drop casting.

In an embodiment of the present disclosure, there is provided an electrode as disclosed herein, wherein the electrode is stable for 13000 to 16000 ADT cycles; and durable for a time period in a range of 150 to 550 hours. In another embodiment of the present disclosure, the electrode is stable for 14000 to 15500 ADT cycles; and durable for a time period in a range of 170 to 525 hours. In yet another embodiment of the present disclosure, the electrode is stable for 15000 ADT cycles; and durable for a time period in a range of 200 to 500 hours.

In an embodiment of the present disclosure, there is provided an electrode as disclosed herein, wherein the electrode is stable for 13000 to 16000 ADT cycles; and durable for a time period in a range of 150 to 550 hours in acidic medium. In another embodiment of the present disclosure, the electrode is stable for 5000 ADT cycles in alkaline medium.

In an embodiment of the present disclosure, there is provided an electrode as disclosed herein, wherein the electrode has electrochemically active surface area (ECSA) in a range of 14 to 18 mF/cm². In another embodiment of the present disclosure, wherein the electrode has electrochemically active surface area (ECSA) in the range of 15 to 17 mF/cm^{2.}

In an embodiment of the present disclosure, there is provided an electrochemical cell comprising: a) a working electrode comprising the electrode a) a substrate; and (b) the catalyst ink comprising: (i) the catalyst comprising: a compound comprising an ordered intermetallic of platinum and germanium having formula Pt₃Ge, wherein Pt₃Ge has a single crystallographic facet oriented in 202 plane; (ii) an activated carbon; and (iii) a binder, wherein the catalyst and the activated carbon is in a weight ratio range of 1:1 to 5:1; b) a counter electrode; and c) a reference electrode, wherein the electrochemical cell exhibits current density is in a range of 1800 to 2200 mA/cm^{2.}

In an embodiment of the present disclosure, there is provided an electrochemical cell as disclosed herein, wherein the electrochemical cell exhibits current density in a range of 1900 to 2100 mA/cm². In another embodiment of the present disclosure, the electrochemical cell exhibits current density of 2000 mA/cm^{2.}

In an embodiment of the present disclosure, there is provided an electrochemical cell as disclosed herein, wherein the electrochemical cell catalyzes hydrogen evolution reaction by electrolysis.

In an embodiment of the present disclosure, there is provided an electrochemical cell as disclosed herein, wherein the counter electrode is selected from graphite rod counter electrode, saturated calomel electrode, mercury/mercuric oxide electrode (MMO), or combinations thereof; and the reference electrode is reversible hydrogen electrode (RHE).

In an embodiment of the present disclosure, there is provided an electrochemical cell comprising: a) a working electrode comprising the electrode (1) a substrate; and (2) the catalyst ink comprising: (i) the catalyst comprising a compound comprising an ordered intermetallic of platinum and germanium having formula Pt₃Ge, wherein Pt₃Ge has a single crystallographic facet oriented in 202 plane; (ii) an activated carbon; and (iii) a binder, wherein the catalyst and the activated carbon is in a weight ratio range of 1:1 to 5:1; b) a counter electrode selected from graphite rod counter electrode, saturated calomel electrode, mercury/mercuric oxide electrode (MMO), or combinations thereof; and c) reversible hydrogen electrode (RHE) as the reference electrode, wherein the electrochemical cell exhibits current density in a range of 1800 to 2200 mA/cm², and the electrochemical cell catalyzes hydrogen evolution reaction by electrolysis.

In an embodiment of the present disclosure, there is provided a process for production of hydrogen, the process comprising: contacting the electrochemical cell comprising: 1) a working electrode comprising the electrode comprising (a) a substrate; and (b) the catalyst ink comprising: (i) the catalyst comprising: a compound comprising an ordered intermetallic of platinum and germanium having Formula Pt₃Ge, wherein Pt₃Ge has a single crystallographic facet oriented in 202 plane; (ii) an activated carbon; and (iii) a binder, wherein the catalyst and the activated carbon is in a weight ratio range of 1:1 to 5:1; 2) a counter electrode; and 3) a reference electrode, wherein the electrochemical cell exhibits current density in a range of 1800 to 2200 mA/cm² with an electrolyte; and generating hydrogen by electrolyzing the electrolyte at an onset potential in a range of 0 V to −0.6 V vs. RHE.

In an embodiment of the present disclosure, there is provided a process for production of hydrogen as disclosed herein, wherein the electrolyte is H₂SO₄ or KOH. In another embodiment of the present disclosure, the electrolyte is 0.5M H₂SO₄. In yet another embodiment of the present disclosure, the electrolyte is 0.5M KOH.

In an embodiment of the present disclosure, there is provided a process for production of hydrogen as disclosed herein, wherein generating hydrogen is carried out at an overpotential in a range of 15 to 25 mV at 10 mA/cm²; and 90 to 100 mV at 200 mA/cm^{2.}

In an embodiment of the present disclosure, there is provided a process for production of hydrogen as disclosed herein, the process comprising: contacting the electrochemical cell comprising: 1) a working electrode comprising the electrode (a) a substrate; and (b) the catalyst ink comprising: (i) the catalyst comprising a compound comprising an ordered intermetallic of platinum and germanium having formula Pt₃Ge, wherein Pt₃Ge has a single crystallographic facet oriented in 202 plane; (ii) an activated carbon; and (iii) a binder, wherein the catalyst and the activated carbon is in the weight ratio range of 1:1 to 5:1; 2) a counter electrode selected from graphite rod counter electrode, saturated calomel electrode, mercury/mercuric oxide electrode (MMO), or combinations thereof; and 3) reversible hydrogen electrode (RHE) as the reference electrode, a counter electrode, wherein the electrochemical cell exhibits current density in a range of 1800 to 2200 mA/cm² with an electrolyte selected from H₂SO₄ or KOH; and generating hydrogen is carried out at an overpotential in a range of 15 to 25 mV at 10 mA/cm² and 90 to 100 mV at 200 mA/cm^{2.}

In an embodiment of the present disclosure, there is provided a cell comprising the electrode or the electrochemical cell as disclosed herein.

In an embodiment of the present disclosure, there is provided an apparatus for production of hydrogen comprising the electrochemical cell comprising: 1) a working electrode comprising the electrode comprising (a) a substrate; and (b) the catalyst ink comprising: (i) the catalyst comprising: a compound comprising an ordered intermetallic of platinum and germanium having formula Pt₃Ge, wherein Pt₃Ge has a single crystallographic facet oriented in 202 plane; (ii) an activated carbon; and (iii) a binder, wherein the catalyst and the activated carbon is in the weight ratio range of 1:1 to 5:1; 2) a counter electrode; and 3) a reference electrode, wherein the electrochemical cell exhibits current density in a range of 1800 to 2200 mA/cm^{2.}

Although the subject matter has been described in considerable detail with reference to certain examples and implementations thereof, other implementations are possible.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may apply.

### Example 1

Preparation of the catalyst

The catalyst Pt₃Ge (202) is prepared by the process as explained herein. 0.3 mmol of K₂PtCl₄, and 0.3 mmol of GeCl₄ for Pt₃Ge (110) and Pt₃Ge (202), and 0.8 mL of lithium triethyl borohydride (reducing agent) were mixed in 18 mL of triethylene glycol (first solvent) with vigorous stirring to obtain the first mixture, and the first mixture was loaded in a 23 mL Teflon-lined autoclave. The autoclave was kept at 220° C. for 36 h and the catalyst Pt₃Ge (202) was obtained. The catalyst was washed several times with ethanol, and the obtained product was dried and used further.

As a comparative example, Pt₃Ge (110) was prepared by the process defined above from 0.3 mmol of K₂PtCl₄, and 0.1 mmol of GeCl₄.

### Example 2

Characteristic analysis of the catalysts

Powder X-ray Diffraction (PXRD)

Catalysts prepared from Example 1 were subjected to powder X-ray diffraction (PXRD) analysis. PXRD measurements were done at room temperature on a Rigaku Miniflex X-ray diffractometer with Cu-Ka X-ray source (2=1.5406 Å), equipped with a position sensitive detector in the angular range 20°≤20≤80° with the step size 0.02° and scan rate of 0.5 s/step calibrated against corundum standards. The experimental XRD patterns were compared to the patterns simulated from the existing reports. FIG. 1 depicts a) the powder X-ray diffraction patterns of the catalyst Pt₃Ge (202) and Pt₃Ge (110) compared with the tetragonal Pt₃Ge 14/mcm and Pt₃Ge₂ Pnma. From FIG. 1a it can be understood that the catalyst of the present disclosure Pt₃Ge (202) had a tetragonal 14/mcm spacegroup. An excess amount of Ge favored the generation of a secondary phase Pt₃Ge₂ along with Pt₃Ge.

The lattice parameters a and b of Pt₃Ge are contracted in the case of higher Ge amount, while an expansion of c parameter observed as it is evident from the Reitveld refinement (Table 1). Table 1 refers to the structural parameters extracted through Rietveld refinement of the powder XRD of Pt₃Ge and Pt₃Ge-Pt₃Ge₂ samples. The anisotropic expansion upon the incorporation of a minor phase Pt₃Ge₂ favored the anisotropic destruction of crystal growth along (110) direction. It can be understood that the presence of Pt₃Ge₂ facilitated the orientation of Pt₃Ge in 202 plane which was due to an excess amount of Ge in the preparation of the catalyst.

TABLE 1

| | | | | | | Wt. Fraction |
|---|---|---|---|---|---|---|
| Catalyst | Phase | a (Å) | b (Å) | c (Å) | χ² | (%) |
| Pt₃Ge | Pt₃Ge | 5.5141 | 5.5141 | 7.8927 | 3.33 | 100.00 |
| (110) | | | | | | |
| Pt₃Ge | Pt₃Ge₂ | 12.227 | 7.509 | 6.829 | 3.76 | 21.6 |
| (202) | Pt₃Ge | 5.4780 | 5.4780 | 7.9164 | | 78.4 |

Scanning electron microscopy (SEM), Energy Dispersive Spectrum (EDS) and Transmission electron microscopy (TEM):

The SEM measurement was performed using Leica scanning electron microscopy equipped with an energy-dispersive X-ray spectroscopy (EDAX) instrument (Bruker 120 eV EDAX instrument). Data were acquired by using an accelerating voltage of 15 kV, and the typical time taken for data accumulation is 100 s. The elemental analyses were performed using the P/B-ZAF standardless method (where P/B=peak to background model, Z=atomic no. correction factor, A=absorption correction factor, and F=fluorescence factor) for Cu, Ga at multiple areas on the sample coated Si wafer.

TEM and high-resolution TEM (HRTEM) images, selected area electron diffraction (SAED) patterns were collected using a JEOL 200 TEM instrument. Samples for these measurements were prepared by dropping a small volume of sonicated nanocrystalline powders in ethanol onto a carbon-coated copper grid.

FIG. 2 (a, b, f, g) depict the high-resolution transmission electron microscopic (HR-TEM) images of the Pt-Ge compounds; FIG. 2 (c, h) depict the scanning electron microscopic images and FIG. 2 (d, e, i, j) depict the colour mapping from energy dispersive X-ray spectrum (EDS) of the Pt-Ge compounds.

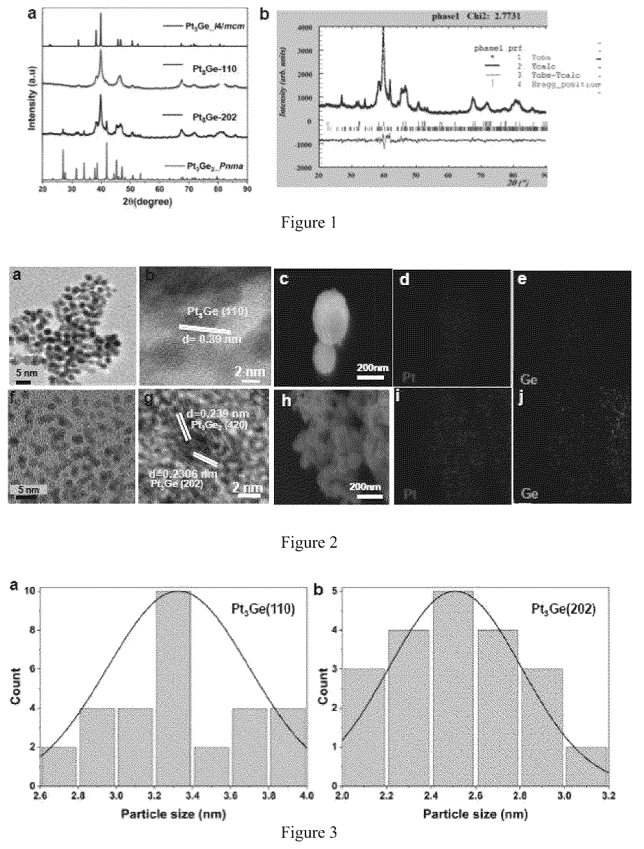

From SEM and EDS analysis it can be observed that Pt₃Ge obtained were in the form of nanospheres (FIGS. 2a and 2f) with average particle size of 2.5 nm and 3.3 nm, respectively for Pt₃Ge (202) and Pt₃Ge (110) (FIGS. 3b and 3a). High-resolution TEM (HR-TEM) image of Pt₃Ge nanoparticles showed the most exposed facet being (110) planes with d-spacing around 0.39 nm (FIG. 2b) and named as Pt₃Ge (110). Whereas HRTEM of the sample with higher Ge (FIG. 2g) showed the existence of Pt₃Ge and Pt₃Ge₂ phases exposing (202) plane for Pt₃Ge and (420) plane for Pt₃Ge₂ and named as Pt₃Ge (202). The catalysts were named with respect to the type of facet exposed in the major phase of Pt₃Ge. The presence of orthorhombic Pt₃Ge₂ phase disrupt the crystal growth along (110) direction and triggered the formation of high energy high-index facet (202) of Pt₃Ge, which was found to be in excellent agreement with the HRTEM analysis, and such facet specific orientation was well reflected in electrochemical performance. In Pt₃Ge (202), Pt₃Ge₂ phase was found to be the sacrificial phase, which was later self-destroyed during the electrochemical HER process. The scanning electron microscopy (SEM) (FIGS. 2c and 2h), color mapping (FIGS. 2c, 2d, 2i and 2j) and point energy dispersive X-ray spectrum (EDX) confirmed the expected elemental composition and in line with the Reitveld refinement.

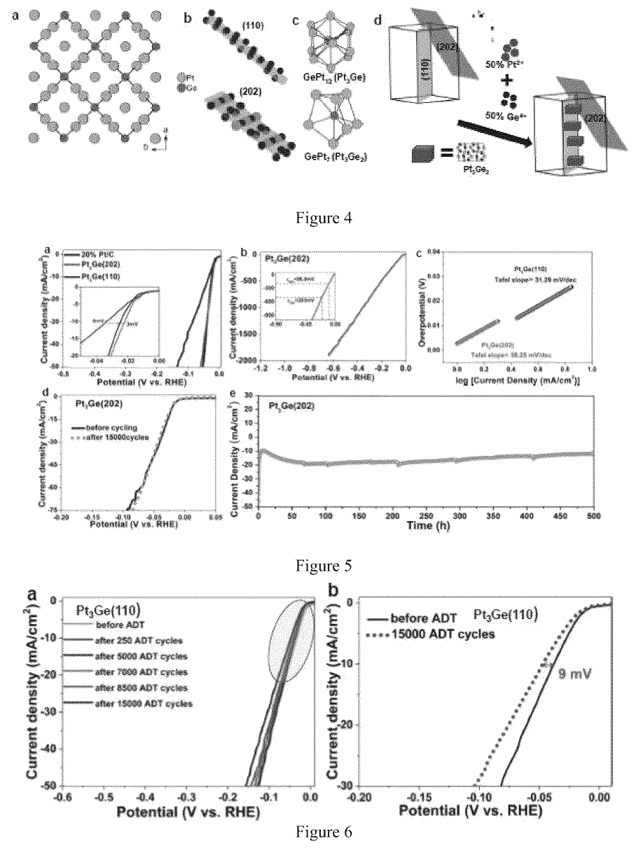

FIG. 4 depicts (a) spatial arrangement of Pt and Ge in Pt₃Ge; (b) crystallographic planes of Pt₃Ge (110) and Pt₃Ge (202); (c) tetragonal phase of Pt₃Ge and Pt₃Ge₂; and (d) the schematic representation of formation of Pt₃Ge (202).

FIG. 4b shows that Pt₃Ge (110) had only Pt atoms at the surface whereas Pt₃Ge (202) had the ordered arrangement of both Pt and Ge. Moreover, as shown in FIG. 4c, Ge is coordinated by 12 Pt atoms in tetragonal phase Pt₃Ge and was surrounded by 7 Pt atoms in orthorhombic Pt₃Ge₂. Thus it can be deduced that lesser Pt precursor gave rise to the catalyst, Pt₃Ge (202).

### Example 3

Production of hydrogen

Electrochemical hydrogen evolution reaction (HER):

All the electrochemical measurements were done in a 3-electrode set-up comprising glassy carbon as the working electrode (GCE), graphite rod as counter electrode, saturated calomel electrode (SCE) (for acidic media) and mercury/mercuric oxide electrode (MMO) (for basic media).

The catalyst ink was prepared using 1.6 mg catalyst with 0.4 mg of vulcan in 200 μL of a mixed solvent (IPA: water=1:1) and 20 μL of 1 wt. % Nafion was used as binder. 10 μL of the catalyst ink was drop casted on the 3 mm glassy carbon electrode to obtain the working electrode of the present disclosure. Commercial Pt/C (20 wt %, Sigma Aldrich) were used for comparison of activity with the reported electrocatalysts.

Linear sweep voltammetry (LSV) was recorded for HER at a scan rate of 5 mV s-1 at 25° C. Electrochemical impedance studies were performed in the frequency range of 10 mHz to 100 kHz at different applied DC potentials for different reactions depending on their onset potential values. The electrolyte solution (0.5M H₂SO₄ or 0.5M KOH) was deaerated by purging nitrogen gas into the solution at least for 30 min before each experiment. All the reference electrodes were calibrated with respect to the reversible hydrogen electrode (RHE), using Pt as working and counter electrodes in the respective electrolytes. The values obtained were as follows: acidic medium, E_{RHE}=E_{SCE}+0.2591 V; alkaline medium, E_{RHE}=EMMO+0.911 V.

FIG. 5a shows the linear sweep voltammograms (LSVs) of Pt₃Ge (110), Pt₃Ge (202), and state-of-the-art catalyst 20% Pt/C in acidic condition (0.5M H₂SO₄). The potential corresponding to 10 mA/cm² current density was found to be 34 mV, 21.7 mV and 24.6 mV, respectively, for Pt₃Ge (110), Pt₃Ge (202) and Pt/C.

FIG. 5b shows the LSV data taken using rotating disk electrode (RDE), which showed current density of 2000 mA/cm² at −0.6V vs. RHE and a remarkably low overpotential of 96.9 mV for 200 mA/cm² current density, which was found to be better than the commercial Pt/C. FIG. 6 showed Pt₃Ge (110) had degradation of 9 mV after 15000 ADT cycles, whereas Pt₃Ge (202) showed no degradation after the 15000 ADT cycles (FIG. 5d). Pt₃Ge (202) exhibited a remarkable 500 hours durability test of chronoamperometry (CA) at 10 mA/cm² as in FIG. 5e, exhibiting the highest stability for any material having the onset potential and overpotential better than Pt/C. The Tafel slope observed was similar in all the catalysts (FIG. 5c) suggesting Volmer-Tafel mechanistic pathway of the HER, with faster kinetics.

Estimation of effective electrode surface area:

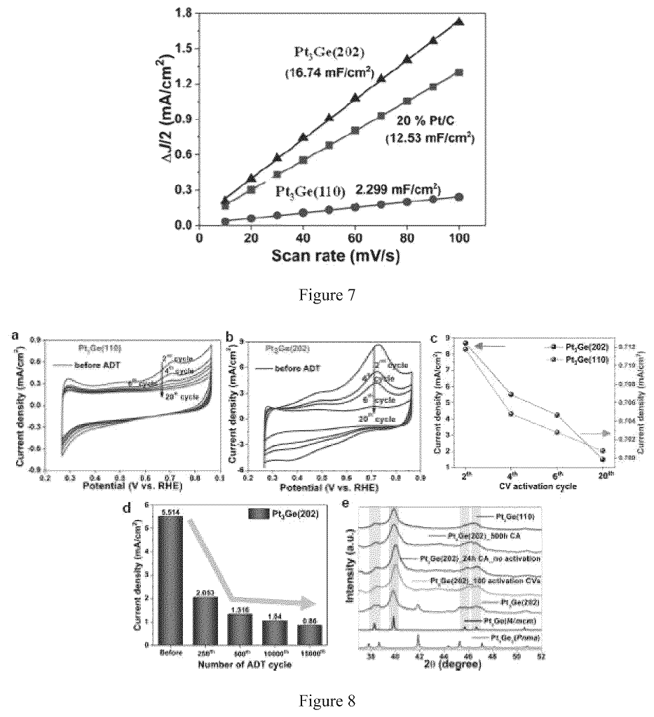

Cyclic voltammetry (CV) was used to determine the electrochemical double layer capacitance at non-Faradaic overpotentials for estimating the effective electrochemically active surface areas (ECSAs). For that a series of CV measurements were performed at various scan rates (10, 20, 30, 40, 50, 60, 70, 80, 90 and 100 s-1) between 0.269 V to 0.469 V vs. RHE region, and the sweep segments of the measurements were set to 6 to ensure consistency. A linear trend was obtained from the plot of the difference of current density (1/2ΔJ) in the anodic and cathodic sweeps (Janodic-Jcathodic) at 0.35 V vs. RHE against the scan rate. The slope of the fitting line was equal to twice the geometric double layer capacitance (Cdl), which was proportional to the effective ECSA of the materials. Therefore, the electrochemical surface areas of different samples were compared based on their Cdl values keeping other experimental condition same for each case. ECSA was calculated from double-layer capacitance (FIG. 7), showing Pt₃Ge (202) has highest value.

Cyclic voltammograms in the non-Faradaic region (0.25V to 0.85V) during the activation process of both catalysts are presented in FIGS. 8a and 8b, which clearly showed a notable difference in the Ge leaching in the oxidation sweep. This can be correlated to the difference in the exposed crystallographic planes in different synthesis procedure. It can be observed from structure of Pt₃Ge (FIG. 4) that Pt₃Ge (110) had only Pt atoms at the surface whereas Pt₃Ge (202) had both Pt and Ge. Pt₃Ge (202) possessed dodeca-coordinated Ge (GePt12) in tetragonal phase Pt₃Ge and hepta-coordinated Ge (GePt7) in orthorhombic Pt₃Ge₂ (FIG. 4c) phase. Due to being less coordinated by Pt. Ge in Pt₃Ge₂ was prone to get leached. These factors favored the catalyst Pt₃Ge (202) with more Ge dissolution than Pt₃Ge (110).

The dissoluted Ge in the electrolyte was verified by Inductively Coupled Plasma-Optical Emission Spectrometry (ICP-OES). With increasing cycles, the peak intensity decreases (FIGS. 8a and 8b), indicating majority of the Ge atoms at the surface are leached in the first few cycles. At the 20th cycle, there was no peak indicating no further Ge is prone to dissolution. FIG. 8c showed that for both catalysts Ge leaching decreased with increasing activation cycles and the amount of leaching was higher in Pt₃Ge (202) as seen in higher current density. However, after a prolonged period Ge being leached out re-deposits on the surface during the reduction potential, and this re-deposited Ge again leaches out, which then completely stopped after 15,000 cycles of ADT confirming no more oxidizable Ge present at the surface (FIGS. 8d and 8e). FIG. 8d showed that immediately after first 250 ADT cycles there was a huge drop in Ge leaching, which gradually decreased further after 500 cycles. Then Ge leaching reached a limiting point after 500, 10000 and 15000 ADT cycles. This indicated that with gradual progress of reaction, the surface of the catalyst undergo a stable reconstruction after which no more Ge was oxidizable. This surface stabilized the HER kinetics which in turn exhibited 500 hours stability during CA (CV activation cycle). The controlled experiment confirmed the formation of Ge cation.

Post-HER PXRD pattern confirmed the generation of Pt₃Ge (202) upon the self-disruption of Pt₃Ge₂ phase during the electrochemical process (FIG. 8e). The catalyst was exposed to oxidation potential for 100 activation CVs and 24 hours CA without any activation and 500 hours CA and then PXRD was taken. All these three conditions made the catalyst reached similar fate, that is, total collapse of the sacrificial phase Pt₃Ge₂. The catalyst transformed to only Pt₃Ge (202) phase.

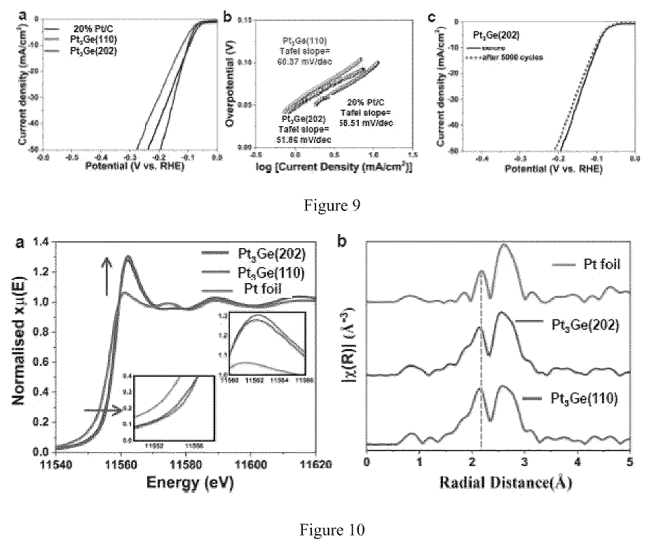

The viability of the catalysts were observed in multiple operation conditions, and hence the activity was checked in the alkaline medium (0.5M KOH). Pt₃Ge (202) catalyst achieved 10 mA/cm² current density at only 96 mV which was on par with the state-of-the-art catalyst 20% Pt/C (FIG. 9a) and exhibit significant stability up to 5000 ADT cycles (FIG. 9c) with no degradation in nio value. The Tafel slope was 51.86 mV/dec which was smaller than 20% Pt/C (FIG. 9b) signifying faster HER reaction kinetics compared to Pt/C even in alkaline media, which also portrayed in the LSV where Pt₃Ge (202) has lesser overpotential compared to 20% Pt/C at entire current density. Table 2 provides a summary of the results obtained from HER rection using catalyst of the present disclosure Pt₃Ge (202) in comparison with Pt₃Ge (110) and 20% Pt/C. n₁₀ and n₂₀ indicate the overpotentials corresponding to 10 and 20 mA/cm² current density. The lesser these overpotential values were and hence the better was the performance of the catalyst.

TABLE 2

| | | | | | Stability (ADT |
|---|---|---|---|---|---|
| Electrolyte | Catalyst | η₁₀ (mV) | η₂₀(mV) | Tafel (mV/dec) | cycles) |
| 0.5M H₂SO₄ | Pt₃Ge (110) | 34 | 58.2 | 31.29 | 7,000-8,000 |
| | Pt₃Ge (202) | 21.7 | 30.7 | 30.25 | 15,000 (500 h |
| | | | | | CA) |
| | 20% Pt/C | 24.6 | 32.2 | 30.55 | 5,000 |
| 0.5M KOH | Pt₃Ge (110) | 119 | 162 | 60.37 | 2,000 |
| | Pt₃Ge (202) | 96 | 124.7 | 51.86 | 5,000 |
| | 20% Pt/C | 96.7 | 131.4 | 58.51 | 1,000 |

X-ray absorption near edge spectroscopy (XANES) and quick-Extended X-ray Absorption Fine Structure (quick-EXAFS):

XANES and EXAFS experiments were performed at 300 K. Measurements of Pt-k edges at ambient pressure were performed in fluorescence as well as transmission mode using gas ionization chambers to monitor the incident and transmitted X-ray intensities. Monochromatic X-rays were obtained using a Si (111) double crystal monochromator which was calibrated by defining the inflection point (first derivative maxima) of Cu foil as 8980.5 eV. The beam was focused by employing a Kirkpatrick-Baez (K-B) mirror optic. A rhodium-coated X-ray mirror was used to suppress higher order harmonics. A CCD detector was used to record the transmitted signals. Pellets for the ex-situ measurements were made by homogeneously mixing the sample with an inert cellulose matrix to obtain an X-ray absorption edge jump close to one. Background subtraction, normalization, and alignment of the EXAFS data were performed by ATHENA software. Theoretical XAFS models were constructed and fitted to the experimental data in ARTEMIS.

The charge transfer was confirmed by X-ray absorption (XAS). Pt L3-edge spectra X-ray absorption Near Edge spectra (XANES) and X-ray absorption fine structure (XAFS) R-space data are shown in FIG. 10a and FIG. 10b, respectively. The intensity of the white line was the order of the unoccupied electronic state, which was correlated to the oxidation state of an atom. From FIG. 10a, the increasing order of oxidation state was found to be Pt<Pt₃Ge (202)<Pt₃Ge (110). Among the two catalysts, the Pt in Pt₃Ge (110) existed in higher positive than Pt₃Ge (202). Lower oxidation state of Pt in Pt₃Ge (202) depicted that there was charge transfer (electron transfer) from Ge to Pt only in the case of Pt₃Ge (202).

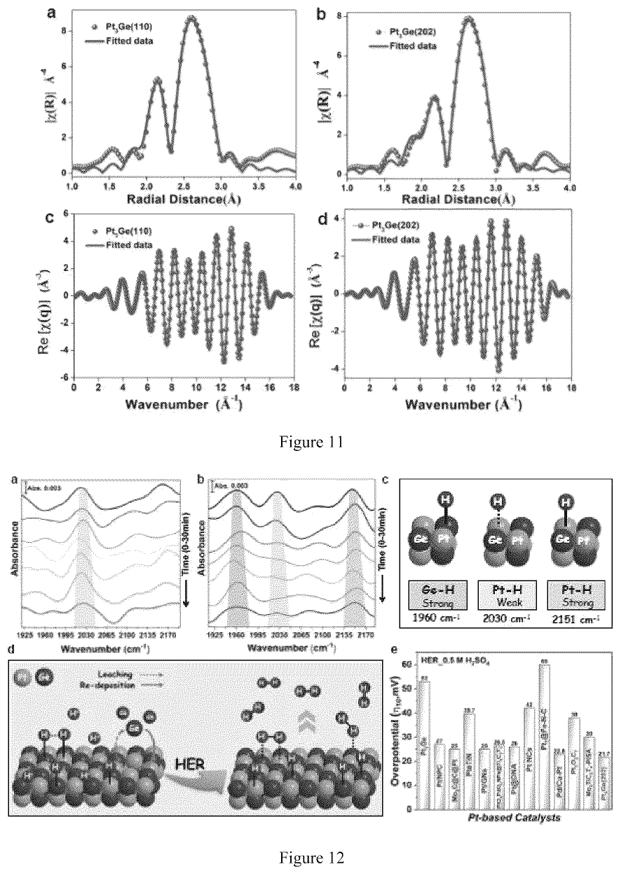

The charge transfer from Ge to Pt was playing a crucial role in enhancing the HER kinetics since the electron-donating capability of Pt to the proton was found to be highly increased than that in metallic Pt. The R-space data showed that Pt-Pt and Pt-Ge bond lengths were at relevant positions (FIG. 10b). Pt-Pt bond length peak slightly shifted to a smaller distance than Pt foil, indicating bond contraction, which was due to the higher oxidation state of Pt in Pt₃Ge than elemental foil. There are almost no Pt-O bonds below 2 Å distance which meant no oxide formation in the bulk catalyst for either of the catalysts. In metallic Pt, the charge transfer was less as compared to the Pt₃Ge (202) confirming the enhanced HER activity. FIG. 11 showed the fitted R-space and k-space data of both the catalysts and Table 3 shows the fitting parameters.

TABLE 3

| Catalyst | Path | CN | E₀ | ΔR | R_{eff} | R |
|---|---|---|---|---|---|---|
| Pt₃Ge | Ge.1 | 0.75 | 5.468 | 0.0302 | 2.4639 | 2.4941 |
| (110) | Pt1.1 | 5.75 | 5.468 | −0.0674 | 2.8258 | 2.7583 |
| Pt₃Ge | Ge.1 | 1.5 | 5.355 | 0.0514 | 2.4639 | 2.5153 |
| (202) | Pt1.1 | 5.025 | 5.355 | −0.0566 | 2.8258 | 2.7691 |

In-situ electrochemical Fourier Transformed Infrared spectroscopy (FT-IR):

In-situ electrochemical FT-IR spectroscopic studies were performed using a purged VERTEX FT-IR spectrometer equipped with the A530/P accessory and a mid-band MCT detector. A silicon hemispherical window (F530-8) was used with the working electrode placed 1 mm above the window as the single reflection attenuated total reflection (ATR) accessory for the FTIR study. The measurement parameters were 4 cm-1 resolution and 100 scans. This setup enabled the detection of Pt-H and Ge-H bonds and mechanism of HER as well as within the thin-layer electrolyte.

The enhanced performance of Pt₃Ge (202) compared to the commercial Pt/C can be explained if the mechanism of the HER can be mapped in operando condition. For this, in-situ IR spectroscopy was performed during a 30 mins chronoamperometric study of Pt₃Ge (110) and Pt₃Ge (202) for 10 mA/cm² (FIGS. 12a and 12b). It is known that Pt-H and Ge-H bonds show a stretching frequency at 2030-2150 cm-1 and 1960 cm-1, respectively. It can be observed that the catalyst Pt₃Ge (110) showed a prominent and constant peak at 2030 cm-1 corresponding to Pt-H weak bond stretching vibration and slight peak at 2151 cm-1 with some strong Pt-H strong bond vibrations. Whereas the catalyst Pt₃Ge (202) showed prominent peaks at 1960 cm-1 and 2151 cm-1 corresponding to stretching vibrations of strong Ge-H and Pt-H bonds. In Pt₃Ge (202), at the first few minutes there were peaks at 2030 cm-1 which after some time vanished due to no weaker Pt-H bond exists and all hydride bonds of Pt and Ge were strong bonds. FIG. 12c showed all the probable stretching vibrational frequencies. FIG. 12d showed the schematic of the HER mechanism as derived from the in-situ ATR FTIR studies.

Finally, there is a combined plot where all the reported best Pt-based catalyst for acidic HER as in FIG. 12e.

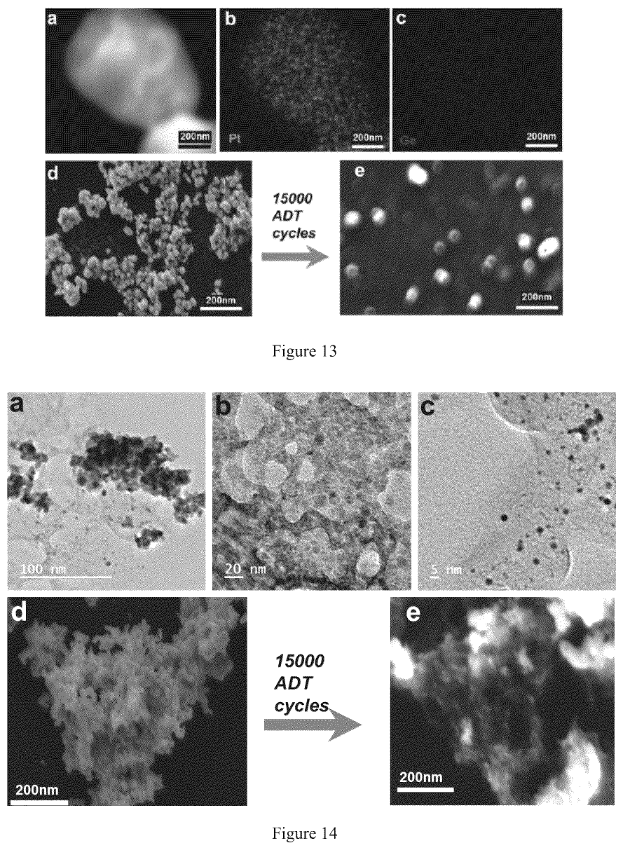

Post-HER microscopic studies (FIGS. 13 and 14) corroborate the changes observed in the XRD. FIG. 13 depicts the Pt₃Ge (110) nanocrystals with reduced Ge concentration at the edges compared to the core confirmed the dissolution of Ge. FIG. 13 depicts (a) SEM image of a Pt₃Ge (110); (b) and (c) the color mapping of Pt and Ge in Pt₃Ge, respectively; and (d) SEM image showing particles before and (e) after 15000 ADT cycles. These images showed that after electrochemistry well-dispersed particles have slightly agglomerated. FIG. 14 depicts (a) and (b) TEM image of a Pt₃Ge (110) nanoparticle, and (c) TEM image of a Pt₃Ge (202) nanoparticle; (d) SEM image showing particles before and (e) after 15000 ADT cycles of Pt₃Ge (202). The images of FIGS. 14d and 14e showed that after electrochemistry Pt₃Ge (202) have formed a cage like structure which supported the observation of phase collapse of Pt₃Ge₂. Though TEM images indicated the agglomeration of Pt₃Ge (202) nanoparticles (FIG. 14c), SEM images showed porous network-like structure due to the elemental leaching (FIGS. 14 d-e). As tabulated in Table 4, the Ge atomic percentage in both the catalysts decreased after HER with larger decrement for Pt₃Ge (202). All these controlled studies clearly manifest that Ge leaching was predominant in the case of Pt₃Ge (202), which can be easily correlated with the un-coordinated Ge atom in morphology guider in Pt₃Ge₂.

TABLE 4

| | |
|---|---|
| Before HER | After HER |

| Catalyst | Pt at % | Ge at % | Pt at % | Ge at % |
|---|---|---|---|---|
| Pt₃Ge | 76.22 | 23.78 | 82 | 18 |
| (110) | | | | |
| Pt₃Ge | 66.36 | 33.64 | 79.64 | 20.37 |
| (202) | | | | |

The above examples clearly illustrated that the synthetically tuned Pt₃Ge (202) catalyst of the present disclosure surpasses the onset potential of Pt and exhibit excellent stability having much lower onset potential and faster kinetics compared to all other Pt-based catalysts. The specific crystallographic orientation provided the catalyst a higher ECSA, a higher stability and electrochemical activity. The controlled electrochemical measurements supported by ex-situ and operando IR spectroscopic studies provided the higher activity of the catalyst Pt₃Ge (202) in comparison to Pt₃Ge (110) and Pt/C catalysts. The leaching of Ge was seen controlled, and existence of the Pt₃Ge₂ phase created a strain and caused the anisotropic expansion of Pt₃Ge which favored the enhancement of the HER activity in Pt₃Ge (202). The induced structural changes altered the charge transfer from Ge to Pt, which enhanced the electron transfer from Pt site to H+. The presence of Ge can form GeHx in HER reactions, also caused an enhanced HER kinetics. Thus the catalyst Pt₃Ge (202) of the specific crystallographic plane exhibited enhanced production of hydrogen through HER reaction.

### ADVANTAGES OF THE PRESENT DISCLOSURE

The above-mentioned implementation examples as described on this subject matter and its equivalent thereof have many advantages, including those which are described.

The present disclosure provides a catalyst comprising an ordered intermetallic compound comprising of platinum and germanium having Formula Pt₃Ge with a single crystallographic facet oriented in 202 plane. The present disclosure also provides a catalyst Pt₃Ge (202) stabilizing in tetragonal crystal system with space group 14/mcm. The specific orientation of the catalyst provides a higher catalytic activity due to their enhanced stability. The present disclosure also provides a process for preparing the catalyst and the higher amount of Ge precursor in the preparation allows the formation of Pt₃Ge₂ which plays a significant role in the growth of the crystal in 202 plane only. The synthetically tuned Pt₃Ge (202) surpasses the onset potential of Pt and exhibits excellent stability having much lower onset potential and faster kinetics in the hydrogen evolution reaction.

The present disclosure also provides a catalyst ink and an electrode comprising the catalyst ink. The electrode comprising the catalyst ink obtained from the catalyst Pt₃Ge exhibits lower overpotential and lower onset potential when compared to state of art Pt catalysts. The electrode of the present disclosure possesses wide range of application and is stable in both alkaline and acidic medium. The electrode is stable for 13000 to 16000 ADT cycles; and durable for a time period in the range of 150 to 550 hours. The electrode has higher electrochemically active surface area (ECSA) in the range of 14 to 18 mF/cm². The present disclosure also provides an electrochemical cell which can provide higher current density in the range of 1800 to 2200 mA/cm². The present disclosure also provides a cell comprising the electrode and an apparatus for the production of hydrogen by hydrogen evolution reaction.

1. A catalyst comprising:
a compound comprising an ordered intermetallic of platinum and germanium, having formula Pt₃Ge,
wherein Pt₃Ge has a single crystallographic facet oriented in 202 plane.

2. The catalyst as claimed in claim 1, wherein the compound crystallizes in tetragonal system having a space group 14/mcm.

3. The catalyst as claimed in claim 1, wherein the catalyst exhibits an overpotential in a range of 15 mV to 25 mV at 10 mA/cm² in acidic medium and 90 mV to 98 mV at 10 mA/cm² in alkaline medium.

4. A process for preparing the catalyst as claimed in claim 1, the process comprising:
a. mixing a platinum precursor, a germanium precursor, and a reducing agent in a first solvent to obtain a first mixture;
b. heating the first mixture at a temperature in a range of 200 to 250°° C. for a time period in a range of 24 to 48 hours to obtain the catalyst,
wherein the platinum precursor and the germanium precursor is taken in a molar ratio range of 0.9:0.8 to 1.5:1.2.

5. The process as claimed in claim 4, wherein the platinum precursor is K₂PtCla; the germanium precursor is GeCh; the reducing agent is lithium triethyl borohydride; and the first solvent is triethylene glycol.

6. The process as claimed in claim 4, wherein the catalyst is subjected to washing and drying.

7. A catalyst ink comprising:
a. the catalyst as claimed in claim 1;
b. an activated carbon; and
c. a binder,
wherein the catalyst and the activated carbon is in a weight ratio range of 1:1 to 5:1.

8. The catalyst ink as claimed in claim 7, wherein the catalyst ink further comprises a second solvent selected from water, isopropanol, or combinations thereof.

9. The catalyst ink as claimed in claim 7, wherein the activated carbon is vulcan;
and the binder is nafion.

10. An electrode comprising:
a. a substrate; and
b. the catalyst ink as claimed in claim 7.

11. The electrode as claimed in claim 10, wherein the substrate is glassy carbon and the substrate is coated with the catalyst ink by drop casting.

12. (canceled)

13. The electrode as claimed in claim 10, wherein the electrode is stable for 13000 to 16000 ADT cycles; and durable for a time period in a range of 150 to 550 hours; and the electrode has electrochemically active surface area (ECSA) in a range of 14 to 18 mF/cm^{2.}

14. (canceled)

15. An electrochemical cell comprising:
a. a working electrode comprising the electrode as claimed in claim 10;
b. a counter electrode; and
c. a reference electrode,
wherein the electrochemical cell exhibits current density in a range of 1800 to 2200 mA/cm^{2.}

16. The cell as claimed in claim 15, wherein the electrochemical cell catalyzes hydrogen evolution reaction by electrolysis.

17. The cell as claimed in claim 15, wherein the counter electrode is selected from graphite rod counter electrode, saturated calomel electrode, mercury/mercuric oxide electrode (MMO), or combinations thereof; and the reference electrode is reversible hydrogen electrode (RHE).

18. A process for production of hydrogen, the process comprising:
a. contacting the electrochemical cell as claimed in claim 15 with an electrolyte; and
b. generating hydrogen by electrolyzing the electrolyte at an onset potential in a range of 0 to −0.6V vs RHE.

19. The process as claimed in claim 18, wherein the electrolyte is H₂SO₄ or KOH.

20. The process as claimed in claim 18, wherein generating hydrogen is carried out at an overpotential in a range of 15 to 25 mV at 10 mA/cm² and 90 to 100 mV at 200 mA/cm².

21. A cell comprising the electrode as claimed in claim 10.

22. An apparatus for production of hydrogen, comprising the electrochemical cell as claimed in claim 15.
